(19) United States
(12) Patent Application Publication
(10) Pub. No.: US 2009/0154550 A1
(43) Pub. Date: Jun. 18, 2009

(54) INFORMATION PROCESSING APPARATUS

(75) Inventors: Yuuichiro Aso, Hamura-shi (JP); Nobuaki Inomata, Nishitama-gun (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/186,280

(22) Filed: Aug. 5, 2008

(30) Foreign Application Priority Data
Dec. 13, 2007 (JP) 2007-322552

(51) Int. Cl. H04N 11/02

(52) U.S. Cl. 375/240.01; 375/E07.076

(57) ABSTRACT

An information processing apparatus includes: a decoder to decode video data to a video signal; a graphic processing module to perform a video quality adjustment on the video signal decoded by the decoder; a display device to display video generated from the video signal; a connector for outputting the video signal to an external device; a display driver module to set an output target, to which the video signal is to be outputted; a determining module to determine to subject the video signal to the video quality adjustment performed by the graphic processing module, in accordance with the output target set by the display module.

### CROSS-REFERENCE TO RELATED APPLICATIONS

This application is based upon and claims the benefit of priority from Japanese Patent Application No. 2007-322552, filed on Dec. 13, 2007, the entire content of which are incorporated herein by reference,

### BACKGROUND

1. Field

One embodiment of the present invention relates to an information processing apparatus that outputs a video signal.

2. Description of the Related Art

In recent years, personal computers that are capable of receiving TV broadcasting programs, displaying the video generated from the video signal, and playing AV (Audio and Visual) contents stored in a DVD (Digital Versatile Disk) have been widely used. Accordingly, by using a notebook-type personal computer that is powered by a battery, utilization of video data including such AV contents is available to a user while the user is away from home.

In addition, with progress of utilization of high-resolution video, personal computers, which are capable of playback high-resolution video data stored in recording medium, are starting to become widely used. Since such personal computers may have a capability to output high-resolution video signal to external devices, a user can connect the personal computer to a wide-screen high-resolution monitor while the user is at home and enjoy high-resolution video played by the personal computers with the wide-screen high-resolution monitor.

There has been proposed a technique to perform video quality adjustment process to a video signal that is obtained by decoding video data, thereby improving video quality. The video quality adjustment process may include gamma correction, sharpness improvement, and memory color correction. An example of such technique is disclosed in

However, when performing the video quality adjustment process, parameters for the adjustment are generally determined in accordance with a display device for displaying the video. Accordingly, for example, when a personal computer performs the video quality adjustment process and outputs processed video signal to an external monitor, video quality may not be improved as much as supposed due to a difference in display characteristic between the monitor and a display device provided in the personal computer. In addition, some monitors, such as TV broadcasting receivers, are designed to perform their own video quality adjustment process. In this case, since video quality adjustment process performed twice for the video image, the video quality of the video image may rather be deteriorated and, for example, being emphasized with a particular color.

### SUMMARY

According to one aspect of the present invention, there is provided an information processing apparatus including: a decoder that decodes video data to generate a video signal; a graphic processing module that performs a video quality adjustment on the video signal decoded by the decoder; and a display device that displays video generated from the video signal; a connector for outputting the video signal to an external device; a display module that selects an output target, to which the video signal is to be output, from the display device and the external device; and a switching module that controls the graphic processing module to change the video quality adjustment in accordance with the output target selected by the display module.

### BRIEF DESCRIPTION OF THE SEVERAL VIEWS OF THE DRAWINGS

A general configuration that implements the various feature of the invention will be described with reference to the drawings. The drawings and the associated descriptions are provided to illustrate embodiments of the invention and not to limit the scope of the invention.

FIGS. 1A and 1B are views showing examples of usage of an information processing apparatus according to a first embodiment of the present invention.

FIG. 2 is a view showing a configuration of the information processing apparatus according to the first embodiment.

FIG. 3 is a view showing functional blocks related to a video quality adjustment function implemented in the information processing apparatus according to the first embodiment.

FIG. 4 is a flow chart showing an operation sequence of video quality adjustment function control in the information processing apparatus according to the first embodiment.

FIG. 5 is a view showing functional blocks related to a video quality adjustment function implemented in an information processing apparatus according to a second embodiment.

FIG. 6 is a flow chart showing an operation sequence of video quality adjustment function control in the information processing apparatus according to the second embodiment.

### DETAILED DESCRIPTION

Hereinafter, an information processing apparatus of the present invention will be described with reference to the accompanying drawings.

### First Embodiment

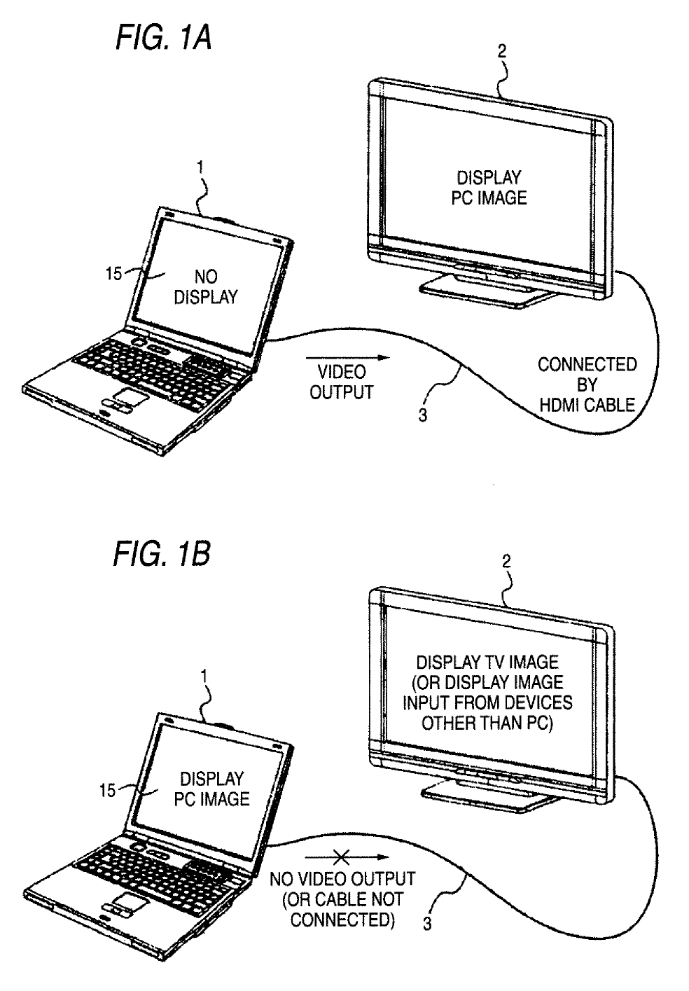

FIGS. 1A and 1B show examples of usage of an information processing apparatus 1 according to an embodiment of the present invention. In the following description, the information processing apparatus 1 is assumed to be configured as a notebook-typed personal computer (PC).

As shown in FIGS. 1A and 1B, it is assumed that the information processing apparatus 1 is connected to an external display 2 (external device) via a HDMI (High-Definition Multimedia Interface) cable 3. The external display 2 is a wide-screen high-resolution television broadcasting receiver (TV). Various kinds of software (application programs) to play high-resolution video data are installed in the information processing apparatus 1, and high-resolution video played by the application programs can be enjoyed through the external display 2 when the information processing apparatus 1 is connected to the external display 2 via the HDMI cable 3. The information processing apparatus 1 and the external display 2 interconnected via the HDMI cable 3 can exchange various kinds of commands (control signals) to control operation of a connection counterpart via the HDMI cable 3.

An output control process of a video signal in the information processing apparatus 1 according to the embodiment will be described with reference to FIGS. 1A and 1B. Resources of the information processing apparatus 1 implemented as a PC are managed by an OS, and a display driver as one of modules provided in the OS controls switching of an output target of the video signal.

In more detail, the video signal is outputted to an built-in display 15 to be displayed on the built-in display 15, such as an LCD panel, of the apparatus 1, as shown in FIG. 1A. The video signal may be externally outputted via a HDMI connector, as shown in FIG. 1B, by the display driver. For example, a setting operation for switching to an external target from the display 15 via the HDMI connector is performed based on occurrence of various events, such as when an explicit operation input by a user, an when a power of the information processing apparatus 1 is turned on in accordance with a command input from the external display 2.

The information processing apparatus 1 is configured that, when video data recorded in a DVD employing copy protection, at least the video image obtained by the video data is outputted to at least one of the built-in display 15 and the HDMI connector. According to this configuration, the information processing apparatus 1 can more appropriately observe copy protection.

The information processing apparatus 1 and the external display 2 are assumed to have capability to perform video quality adjustment process to the video signal. The video quality adjustment process may include gamma correction, sharpness improvement, memory color correction, and combinations thereof. Generally, preferable video quality adjustment processes (more specifically, different parameter) varies in accordance with the display device to which the video image is displayed. In addition, if the information processing apparatus 1 and the external display 2 perform their respective video quality adjustment processes separately, video quality may rather be deteriorated as such that a particular color is emphasized. Accordingly, the information processing apparatus 1 switches the video quality adjustment process depending on a target display device to which the video signal is outputted (whether the video signal is outputted to the built-in display 15 or to the external display 2).

In the embodiment, the video quality adjustment process is performed when the video signal is outputted to the built-in display 15, while the video quality adjustment process is not performed when the video signal is outputted to the external display 2. This mechanism can prevent video quality from being deteriorated due to a multiple video quality adjustment process. In addition, since the video quality adjustment process is stopped by the information processing apparatus 1, not by the external display 2. Accordingly, it is possible to use a video adjustment function with parameters and so on adjusted for display of the external display 2, which may make a contribution to more improvement of video quality. Hereinafter, such function will be described in detail.

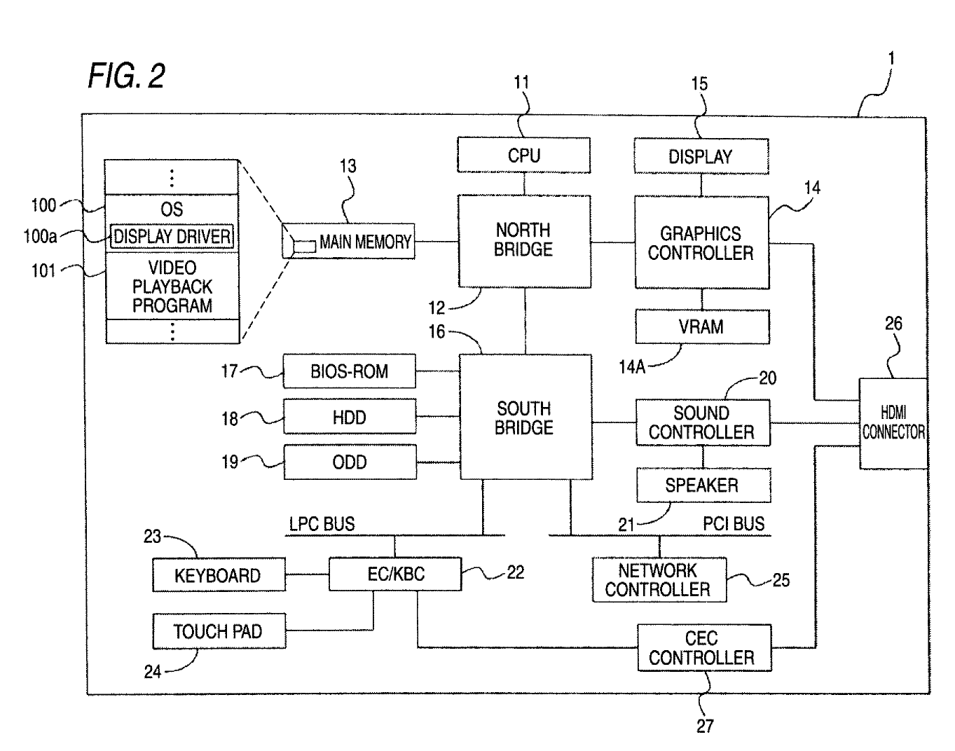

FIG. 2 is a view showing a configuration of the information processing apparatus 1. As shown in FIG. 2, the information processing apparatus 1 includes a CPU 11, a north bridge 12, a main memory 13, a graphics controller 14, a VRAM 14A, a display 15, a south bridge 16, a BIOS-RON 17, a HDD 18, an optical disk driver (ODD) 19, a sound controller 20, a speaker 21, an embedded controller/keyboard controller (EC/KBC) 22, a keyboard 23, a touch pad 24, a network controller 25, an HDMI connector 26, a CEC (Consumer Electronics Control) controller 27.

The CPU 11 is a processor to control other components of the information processing apparatus 1. The CPU 11 runs an operating system (OS) 100 loaded from the HDD 18 into the main memory 13, and application programs that are executed under control of the OS 100 and handle utilities and AV contents data (for example, a video playback program 101). The CPU 11 also executes a basic input/output system (BIOS) stored in the BIOS-ROM 17. In the following description, the basic input/output system itself stored in the BIOS-ROM 17 may also be referred to as BIOS 17.

The north bridge 12 is a bridge device connecting a local bus of the CPU 11 to the south bridge 16. The north bridge 12 has a function to conduct communication with the graphics controller 14 via a bus and contains a memory controller to control access to the main memory 13. The graphics controller 14 is a display controller to control the display 15 of the information processing apparatus 1. The graphics controller 14 generates a video signal, which is to be transmitted to the display 15, from video data recorded in the VRAM 14A. The graphics controller 14 also has a function of outputting the video signal from the HDMI connector 26 to the outside.

The south bridge 16 is a controller to control various devices on a PCI bus and an LPC bus. The south bridge 16 is capable of directly controlling the BIOS-ROM 17, the HDD 18, the ODD 19 and the sound controller 20, which are directly connected to the south bridge 17. The HDD 18 stores TV broadcasting program data, AV contents downloaded through a computer network such as the Internet. The ODD 19 access an HD DVD that stores AV contents data. The sound controller 20 is an audio controller to control the speaker 21. The sound controller 20 is also capable of outputting an audio signal through the HDMI connector 26.

The EC/KBC 22 is a one-chip microcomputer integrated with an embedded controller for power management and a keyboard controller for control of the keyboard 23 and the touch pad 24. The EC/KBC 22 is configured to keep operating even while the information processing apparatus 1 is powered off, in order to monitor whether or not the information processing apparatus 1 is powered on for example, and performs a control to start the information processing apparatus 1 when a power-on event occurs. The EC/KBC 22 also continues to supply power to the CEC controller 27 even while the information processing apparatus 1 is powered off.

The network controller 25 is a communication device to establish communication with a computer network, such as the Internet.

The HDMI connector 26 is a terminal provided to detachably connect the HDMI cable 3 to the apparatus 1. The CEC controller 27 performs a data transfer control to transmit/receive various commands (control signals) for operation control via the HDMI connector 26, under control of the EC/KBC 22. Here, the commands to be transmitted/received may include power-on commands received from the CEC controller 27.

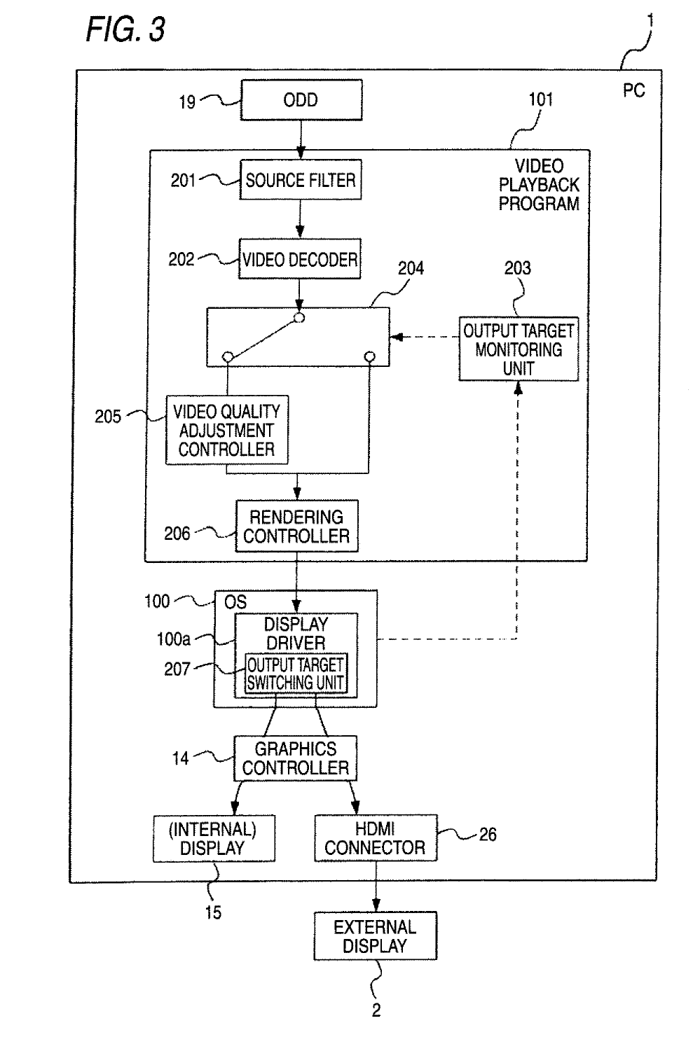

FIG. 3 is a view showing functional blocks related to playback of video data and a video quality adjustment function, which are implemented in the information processing apparatus 1.

For example, under control of a data reading module (source filter) 201, video data read from an optical disk by the ODD 19 are decoded into a video signal by a decoding module (video decoder) 202.

An output target monitoring module 203 detects whether or not an output target switching module 207 of a display driver 100a is set to output the video signal to one of the HDMI connector and the display 15. More specifically, for example, it may be considered to call an API (Application Program Interface), which is provided by the OS 100, to make an inquiry about an output target of the video signal when the video playback program 101 is started or regularly (by polling) after it is started. Alternatively, for example, the OS 100 may be requested in advance to inform occurrence of an event of output target switching.

An adjustment switching module 204 switches the video quality adjustment function for an output of the video signal decoded by the decoding module 202 depending on the output target of the video signal obtained by the output target monitoring module 203. More specifically, the adjustment switching module 204 of the embodiment causes a video quality adjustment controller 205 to perform a video quality adjustment process if the output target of the video signal is set to be the built-in display 15 by the output target switching module 207, and not to perform a video quality adjustment process if the output target of the video signal is set to be the HDMI connector 26. This can prevent a multiple image quality adjustment process by the video quality adjustment controller 205 and the external display 2 when the video signal is outputted from the HDMI connector 26, which may make a contribution to high video quality. In addition, for display of the video signal on the built-in display 15, it is possible for the video quality adjustment controller 205 to perform the video quality adjustment process using video quality parameters optimized for the built-in display 15. In the embodiment, the adjustment switching module 204 controls the graphic processing module to change the video quality adjustment in accordance with the output target set by the display controller.

The video quality adjustment controller 205 performs the video quality adjustment process for the video signal decoded by the decoding module 202. As described above, the video quality adjustment process includes, for example, gamma correction, sharpness improvement, memory color correction, and combinations thereof.

A rendering controller 206 performs a rendering process to record a video in the VRAM 14A from the video signal with the video quality adjusted by the video quality adjustment controller 205 or the video signal decoded by the decoding module 202.

The display driver 100a controls the graphics controller 14 under control of the OS 100. The display driver 10a is provided with the output target switching module 207. The output target switching module 207 of the display driver 100a switches the output target of the video signal, which is output from the rendering controller 206 and temporarily stored in the VRAM 14A, to one of the built-in display 15 and the HDMI connector 26. In the embodiment, the display driver 100a serves as a display controller that sets the output target, to which the video signal is to be output, from the built-in display 15 (display device) and the external display 2 (external device). The display controller may be implemented as software program that is executed by a processor, such as the CPU 11, or may be implemented as a hardware switch.

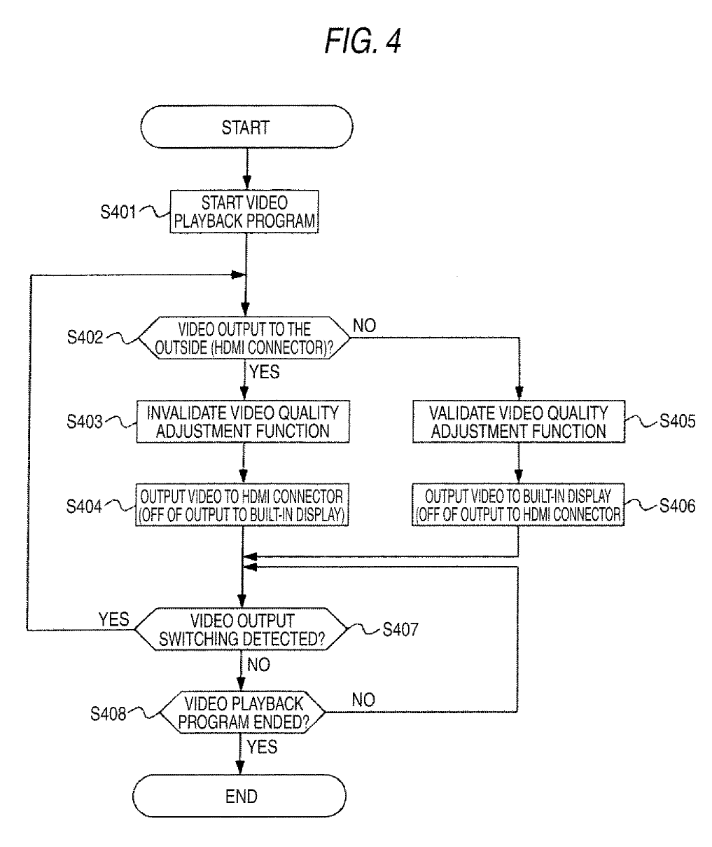

FIG. 4 is a flow chart showing an operation sequence controlled by the video playback program 101 executed by the information processing apparatus 1 of the embodiment.

When the video playback program 101 is started (S401), the output target monitoring module 203 inquires the OS 100 about whether the output target of the video signal is set to be the built-in display 15 or the HDMI connector 26 (S402). If the output target is set to be the HDMI connector 26 (Yes in S402), the adjustment switching module 204 outputs the video signal, which is output from the decoding module 202, to the rendering controller 206 with invalidation of a video quality adjustment process, that is without performing the video quality adjustment process (S403) The display driver 100a outputs the video signal subjected to no video quality adjustment process to the HDMI connector 26 (3404). At this time, in the embodiment, the video signal (at least a video signal obtained by video data playback) is not outputted to the built-in display 15.

On the other hand, if the output target is set to be the built-in display 15 in S402 (No in S402), the adjustment switching module 204 validates the video quality adjustment process (S405). In other words, the adjustment switching module 204 outputs the video signal, which is output from the decoding module 202 and subjected to the video quality adjustment process by the video quality adjustment controller 205, to the rendering controller 206. The display driver 100a outputs the video signal subjected to the video quality adjustment process to the built-in display 15 (S406). At this time, in the embodiment, the video signal (at least a video signal obtained by video data playback) is not outputted to the HDMI connector 26.

After the video signal is output in S404 or S406, if the output target monitoring module 203 detects change of the output target of the video signal (Yes in S407), the process returns to S402 in which the video quality adjustment process is switched.

If the output target of the video signal is not switched (No in S407) and the video playback program 101 is not ended (No in S408), the output target monitoring module 203 continues to monitor the switching of the video output target in S407.

As described above, according to the embodiment, the switching of the video quality adjustment process depends on whether the output target of the video signal is set to be the built-in display 15 or the HDMI connector 26. Accordingly, it is possible to display the video signal on the built-in display 15 with its video quality improved by the video quality adjustment process adaptable for the built-in display 15.

When the video signal is outputted to the HDMI connector 26, since the external display 2 can perform its own video quality adjustment process, it is possible to display the video generated form the video signal on the external display 2 with its video quality improved by the video quality adjustment process adaptable for the external display 2.

Since there is no multiple video quality adjustment process of the information processing apparatus 1 and the external display 2 for the same video signal, it is possible to prevent video quality from being deteriorated due to excessive video quality adjustment.

### Second Embodiment

Next, an information processing apparatus according to a second embodiment of the present invention will be described. In the second embodiment, information on the external display 2 of the output target of the video signal is obtained, and a video quality adjustment process adaptable for the external display 2 is selected from a plurality of video quality adjustment processes and is performed. Accordingly, although the external display 2 has no video quality adjustment function, if a video quality adjustment process (a video quality adjustment parameter) adaptable for the external display 2 is known, video subjected to the video quality adjustment process can be displayed on the external display 2. In addition, since video quality adjustment functions adaptable for the built-in display 15 and the external display 2, respectively, can be performed, it is possible to further improve video quality as compared to one video quality adjustment process (video quality adjustment parameter).

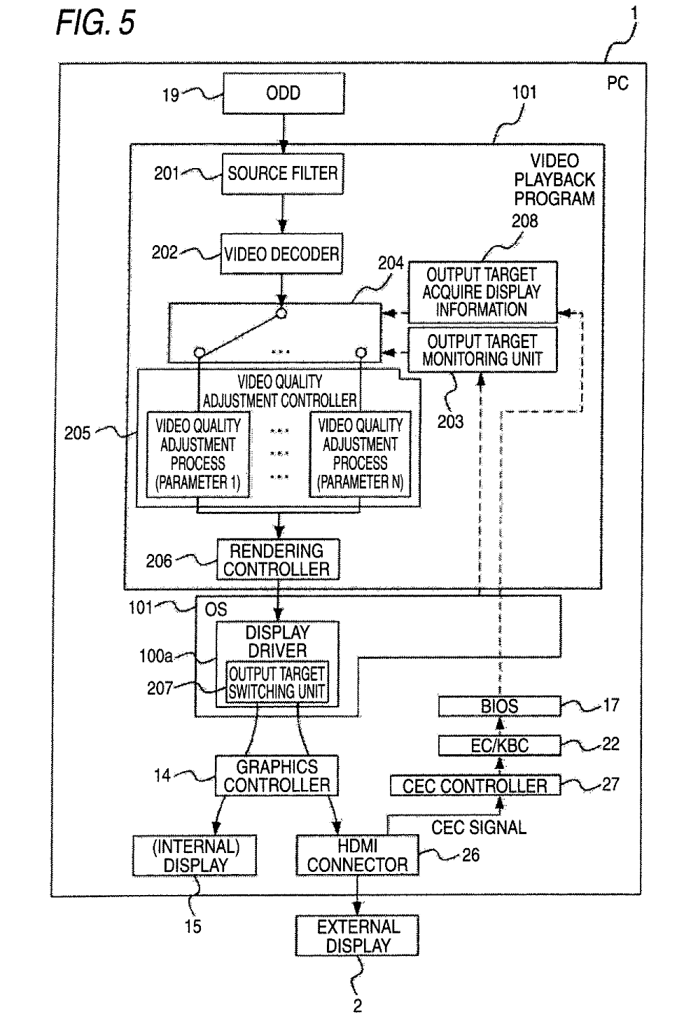

In the second embodiment, the configuration of the information processing apparatus 1 is substantially the same as the information processing apparatus of the first embodiment, and therefore, explanation thereof will be omitted. Now, the operation of the information processing apparatus 1 according to the second embodiment will be described with reference to FIG. 5. FIG. 5 is a view showing functional blocks related to playback of video data and a video quality adjustment function implemented in the information processing apparatus 1 of the second embodiment. In FIG. 5, components that are substantially the same as those shown in FIG. 3 are denoted by the same reference numerals, although some of the components may partly vary from those of the first embodiment. The following description is focused on portions different from first embodiment.

The output target monitoring module 203 detects whether or not the output target switching module 207 of the display driver 100a is set to output the video signal to one of the HDMI connector and the display 15. As described in the first embodiment, whether the output target is set to be the HDMI connector or the display 15 may be detected by, for example, calling an APT, which is provided by the OS 100, to make an inquiry about the output target of the video signal when the video playback program 101 is started or regularly (by polling) after it is started. Alternatively, the output target may be in advance registered in the OS 100 to inform occurrence of an event of output target switching.

If the output target of the video signal is set to be the HDMI connector 26, an output target information obtaining part 208 obtains information of the external display 2 (external display) connected to the HDMI connector 26 via the HDMI cable 3. This information is introduced, as a control signal, into the information processing apparatus 1 via the HDMI connector 26 and is received by the CEC controller 27, and the EC/KBC 22 is informed of the receipt of the control signal. Then, the EC/KBC 22 generates a key code representing the receipt information (information of the external display 2, more specifically, for example, device name/code name, the kind and size of display, etc.) as input data to be sent to the output target information obtaining part 208. The key code is passed to the OS 100 via the BIOS 17 and additionally is passed from the OS 100 to the output target information obtaining part 208. In this manner, since the information of the external display 2 can be obtained by a HDMI-CEC control signal as described above, there is no need to provide a separate cable.

When the adjustment switching module 204 outputs the video quality adjustment function for the output of the video signal decoded by the decoding module 202 to the output target of the video signal obtained by the output target monitoring module 203 and the HDMI connector 26, the adjustment switching module 204 switches the video adjustment function depending on the kind of the external display 2, which is obtained by the output target information obtaining part 208. More specifically, for example, the video quality adjustment controller 205 has a plurality of sets of video quality adjustment parameters including a video quality adjustment parameter adjusted to the built-in display 15, a video quality adjustment parameter adjusted to the external display 2, and the adjustment switching module 204 switches the video quality adjustment process using one of sets of video quality adjustment parameters depending on the output target of the video signal, which is obtained by the output target monitoring module 203 and the output target information obtaining part 208. According to the operation described above, a video quality-adjusted video can be displayed on the external display 2 even if the video signal from the HDMI connector 26, for example, the external display 2, has no video quality adjustment function. In addition, since the video quality adjustment functions adaptable for the built-in display 15 and the external display 2, respectively, can be performed, it is possible to further improve video quality as compared to one video quality adjustment process (set of video quality adjustment parameter).

The video quality adjustment controller 205 performs the video quality adjustment process for the video signal decoded by the decoding module 202 with the video quality adjustment parameter selected by the adjustment switching module 204. This video quality adjustment process includes, for example, gamma correction, sharpness improvement, memory color correction, and combinations thereof.

The rendering controller 206 performs a rendering process to record a video in the VRAM 14A from the video signal with the video quality adjusted by the video quality adjustment controller 205.

The display driver 100a controls driving of the graphics controller 14 under control of the OS 100 and contains the output target switching module 207. The output target switching module 207 of the display driver 100a switches the output target of the video signal (temporarily stored in the VRAM 14A), which is output from the rendering controller 206, to one of the built-in display 15 and the HDMI connector 26.

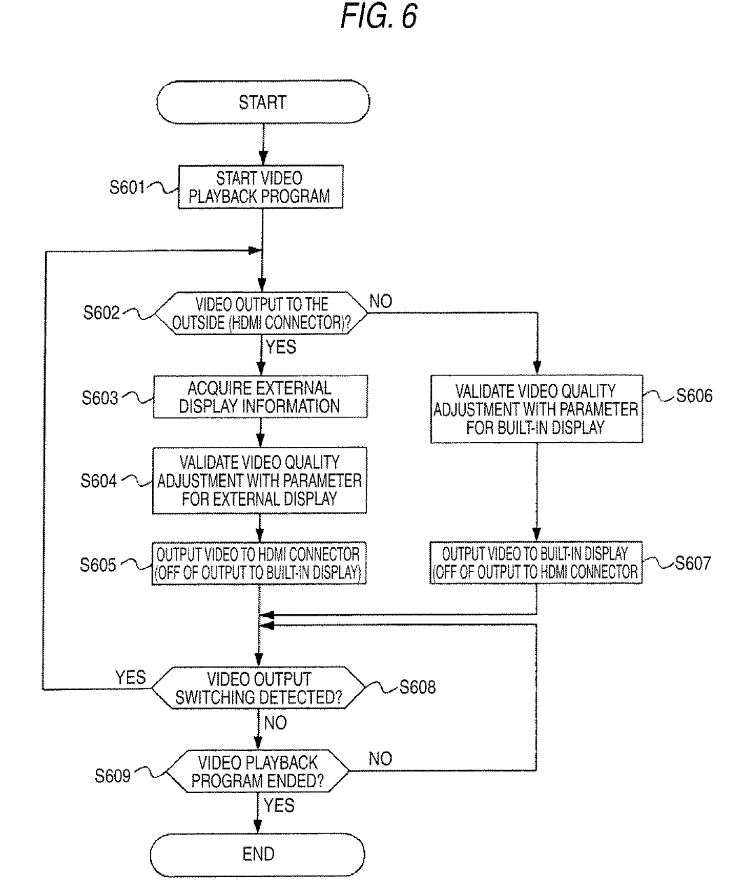

FIG. 6 is a flow chart showing an operation sequence controlled by the video playback program 101 executed by the information processing apparatus 1 of the embodiment.

When the video playback program 101 is started (S601), the output target monitoring module 203 inquires the OS 100 about whether the output target of the video signal is set to be the built-in display 15 or the HDMI connector 26 (S602). If the output target is set to be the HDMI connector 26 (Yes in S602), the output target information obtaining part 208 obtains information of the display device (external display) 2 connected to the HDMI connector 26 (S603).

The adjustment switching module 204 selects a video quality adjustment parameter which is to be used by the video quality adjustment controller 205 and is adaptable for the display device (external display) 2 to output the video signal, and the video quality adjustment controller 205 performs the video quality adjustment process with the selected video quality adjustment parameter (S604). The display driver 100a outputs the video signal subjected to this video quality adjustment process to the HDMI connector 26 (S605). At this time, in the embodiment, the video signal (at least a video signal obtained by video data playback) is not outputted to the built-in display 15.

If the output target is set to be the built-in display 15 in S602 (No in S602), the adjustment switching module 204 selects the video quality adjustment parameter adjusted to the built-in display 15, and the video quality adjustment controller 205 performs the video quality adjustment process with the selected video quality adjustment parameter (S606). The display driver 100a outputs the video signal subjected to the video quality adjustment process to the built-in display 15 (S607) At this time, in the embodiment, the video signal (at least a video signal obtained by video data playback) is not outputted to the HDMI connector 26.

After the video signal is outputted in S605 or S607, if the output target monitoring module 203 detects change of the output target of the video signal (Yes in S608), the process returns to S602 in which the video quality adjustment process is switched.

If the output target of the video signal is not completely switched (No in S608) and the video playback program 101 is not ended (No in S609), the output target monitoring module 203 continues to monitor the video signal output target in S608.

As described above, according to the second embodiment, the switching of the video quality adjustment process depends on whether the output target of the video signal is set to be the built-in display 15 or the HDMI connector 26 and depends on the kind of the external display 2 if the output target is the HDMI connector 26. Accordingly, it is possible to display the video signal with its video quality improved by the video quality adjustment processes adaptable for the built-in display 15 and the external display 2, respectively.

What is claimed is:

1. An information processing apparatus comprising:
a decoder to decode video data to a video signal;
a graphic processing module to perform a video quality adjustment on the video signal decoded by the decoder;
a display device to display video generated from the video signal;
a connector for outputting the video signal to an external device;
a display driver module to set an output target, to which the video signal is to be outputted;
a determining module to determine to subject the video signal to the video quality adjustment performed by the graphic processing module in accordance with the output target set by the display module.

2. The apparatus according to claim 1, wherein the determining module determines to subject the video signal to the video quality adjustment when the output target is the display device, and
wherein the determining module determines not to subject the video signal to the video quality adjustment when the output target is the external device.

3. The apparatus according to claim 1, wherein the display driver module stops to output the video signal to the external device through the connector when the output target is the display device.

4. The apparatus according to claim 1, wherein the display driver module stops to output the video signal to the display device when the output target is the external device.

5. The apparatus according to claim 1 further comprising a detection module to detect the output target set by the display driver module, wherein the determining module determines when the detection module detects a change of the output target.

6. The apparatus according to claim 1, wherein the graphic processing module is capable of performing a first video quality adjustment and a second video quality adjustment that are different from each other, and
wherein the determining module determines to subject the video signal to the first video quality adjustment by the graphic processing module when the output target is the display device, and wherein the determining module determines to subject the video signal to the second video quality adjustment by the graphic processing module when the output target is the external device.

7. The apparatus according to claim 6 further comprising an information obtaining module to obtain information on the external device,
wherein the determining module determines the second video quality adjustment in accordance with the information obtained by the information obtaining module.

8. The apparatus according to claim 7, wherein the information obtaining module obtains the information from a control signal by communication with the external device through the connector.

9. The apparatus according to claim 8 further comprising a detection module to detect the output target set by the display module,
wherein the determining module determines to change the video quality adjustment when the detection module detects a change of the output target.

10. The apparatus according to claim 9, wherein the connector is connectable with a HDMI (High-Definition-Multimedia Interface) cable.
